(19) United States
(12) Patent Application Publication
(10) Pub. No.: US 2014/0344075 A1
(43) Pub. Date: Nov. 20, 2014

(54) System and method for mall marketing

(71) Applicant: Michael Bhaskaran, Bellevue, WA (US)

(72) Inventor: Michael Bhaskaran, Bellevue, WA (US)

(21) Appl. No.: 14/229,019

(22) Filed: Mar. 28, 2014

Related U.S. Application Data
(60) Provisional application No. 61/806,842, filed on Mar. 30, 2013.

(51) Int. Cl. G06Q 30/02; H04N 1/00

(52) U.S. Cl. CPC G06Q 30/0276; H04N 1/00244
USPC 705/14.72

(57) ABSTRACT

A mall marketing and advertising system and method overcomes the drawback of the state of the art sales promotion and advertising methods by providing a provision of selecting and wearing apparels from different store of a mall. The mall models are one of the good standing members of the local community. The image is captured and displayed on website, mall screen and landing page of the local website with mall banner across the image.

### TECHNICAL FIELD OF THE INVENTION

The present invention relates to a mall marketing and advertising method. More specifically the invention relates to a method of displaying images of mall models wearing apparels from different stores of the mall in the screen placed in the mall as well as in the social websites and other sites. The method assists people while doing shopping in a mall and promotes sales.

### BACKGROUND OF THE INVENTION

In present world, lifestyle and living pattern of individuals is changing. More people indulge in shopping nowadays as compared to earlier days. There is a huge increase in demand for apparels in and in the market. Entry of too many fashion designers in the market has led to variety of clothing available for people to be purchased as per their wish. This makes people excited about shopping but at the same time, leaves them with chaos and confusion. The growing number of retail outlets leaves them with confusion about shopping for a specific dress from a specific outlet.

In the prior art U.S. Pat. No. 6,624,843B2, a customer image capture and its use in a retailing system have been disclosed where the system captures images of models wearing apparels at a retailer's place of business. The method does not include any assortment module that can assort apparels from various stores of a mall that the model can wear and showcase in the mall as well as several websites.

In the prior art US20040039592A1, a method and apparatus for supporting apparel product sale and a fitting room is disclosed where an image of customer trying apparel in the fitting room is captured, and it can be displayed with different colors and shades of the same apparel without actually trying them. The method does not provide any provision for assorting clothes from various stores of a mall for customers to wear, and also any customer's not specific mall model can obtain their image captured along with the cloth and displayed for sales promotion purposes. The captured image of the customer is not being displayed in any websites.

Looking at the current scenario, there is need of a system that may assist people while doing shopping in several ways. There may be one way in which photographs of different models can be displayed in the mall, social websites wearing different kind of apparels belonging to different retail shops. In this manner, people can pre-decide about what type of clothes to buy and from which outlet. They can even call up individual retail outlets and inquire about the cost and availability of the desired cloth that they want to buy.

### SUMMARY OF THE INVENTION

The present invention provides a system for capturing an image (s) of mall models and displaying on websites and mall screens for advertising, the system consists of several modules such as a selection module to select mall models among local community for wearing apparels, an assortment module to assort apparels from different stores of a mall that mall models can wear, an image capture module to capture the image of mall models wearing apparels, a display module to display the image of mall models wearing apparels on website and mall and a campaign module for organizing fund raising programs and other events.

The invention discloses a method of capturing image of mall models and displaying on websites and mall screens that consists of following sequential steps starting with selecting apparels to wear from various stores in the mall, assorting apparels form different stores of the mall for mall models to wear in combination, capturing image of the model wearing assorted apparel and finally displaying the captured image in the website as well as on the mall screen.

The method and system of mall marketing provides an advertising method that is used as a sales promotion activity for all the stores of a mall and utilizes a good standing member of the community as the mall model for wearing and displaying selected apparel. This helps the customers to select apparels while shopping and in turn, increases the revenue for the stores selling apparels in the mall.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 is a diagram depicting various components of the system of capturing image of mall models and displaying on websites and mall screens in accordance to one or more embodiments of the invention.

FIG. 2 is a flowchart depicting the method of capturing image of mall models and displaying on websites and mall screens in accordance to one or more embodiments of the invention.

FIG. 3 shows a block diagram depicting the system of capturing image of mall models and displaying on websites and mall screens in accordance to one or more embodiments of the invention.

### DETAILED DESCRIPTION OF THE INVENTION

In order to more clearly and concisely describe and point out the subject matter of the claimed invention, the following definitions are provided for specific terms which are used in the following written description.

By the term “mall model” we mean a person wearing and displaying clothes available in malls for sale, as the context requires.

By the term “selection” we mean an act of carefully choosing something as being the best or most suitable, as context requires.

By the term “assortment” we mean a miscellaneous collection of things for example clothes, as the context requires.

By the term “extracurricular activities” we mean occurrence of an event or activity apart from the realm of the normal curriculum, as the context requires.

By the term “fund raising programs” we mean the process of soliciting and gathering voluntarily for an event to make money, as the context requires.

By the term “mall box” we mean an object that enables capturing of photographs of several mall models wearing clothes, as the context requires.

The present invention relates to an advertising or sales promotion method where a good standing member from local community exhibits the role of a mall model that has to wear apparels from different stores located inside the mall, and their images are captured.

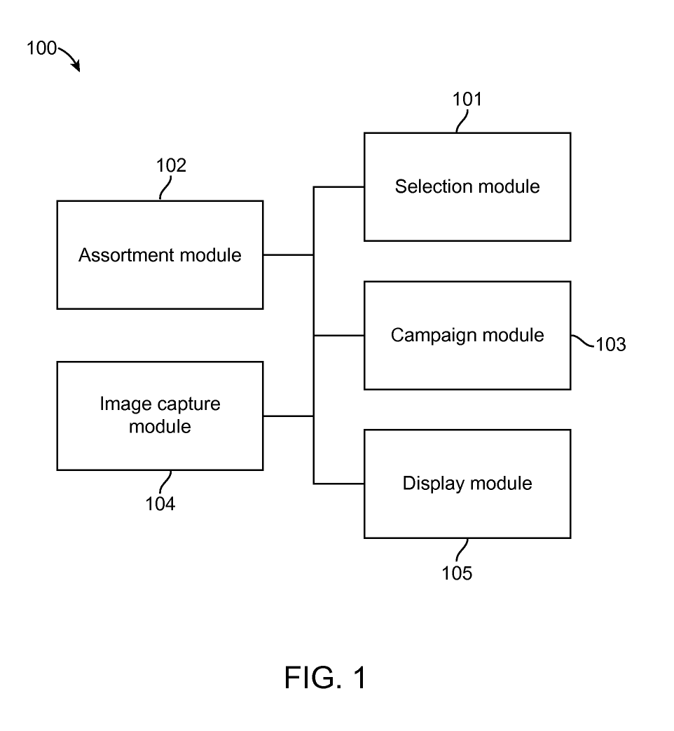

FIG. 1 is a diagram depicting various components of the system of the capturing image of the mall models and displaying on the websites and the mall screens in accordance to one or more embodiments of the invention. The selection module (101) is enabled to assist the mall models (302) in selecting apparels to be worn from different stores (301) of the mall. The assortment module (102) performs an assortment of different apparels from various stores (301) of the mall, the mall models (302) wear assorted apparels that can be captured and displayed on the websites (304) and the mall screens. The campaign module (103) is efficient to attract huge crowd in the mall by organizing various events and programs. Cultural and extracurricular activities organized and performed in the mall contribute to fund raising activities for the mall. The campaign module (103) motivate parents and students to conduct activities such as a reading club, cultural events, and a sports program in the mall to draw traffic. Along with the display of captured image of mall models (302), local businesses such as doctors, lawyers, nail salons, grocery store etc are advertised on the mall screens as well as on the landing page of the local website. As an example, each day seven major advertisements per zip code may be broadcasted. The image capture module (104) is deployed in the mall box (303) and is programmed to capture image of the apparels with or without the mall model (302) in different angles and positions for displaying in the mall screen and the websites (304). The display module (105) is adapted to display the captured image of the apparels with or without the mall models (302) in the mall screen and the social websites such as instagram; flicker, facebook and city's local landing page or other photo sharing sites with the mall banner across the picture. The captured image can also be displayed on the mall model's website along with the link to the mall website where the image is hosted, only if the model grants permission.

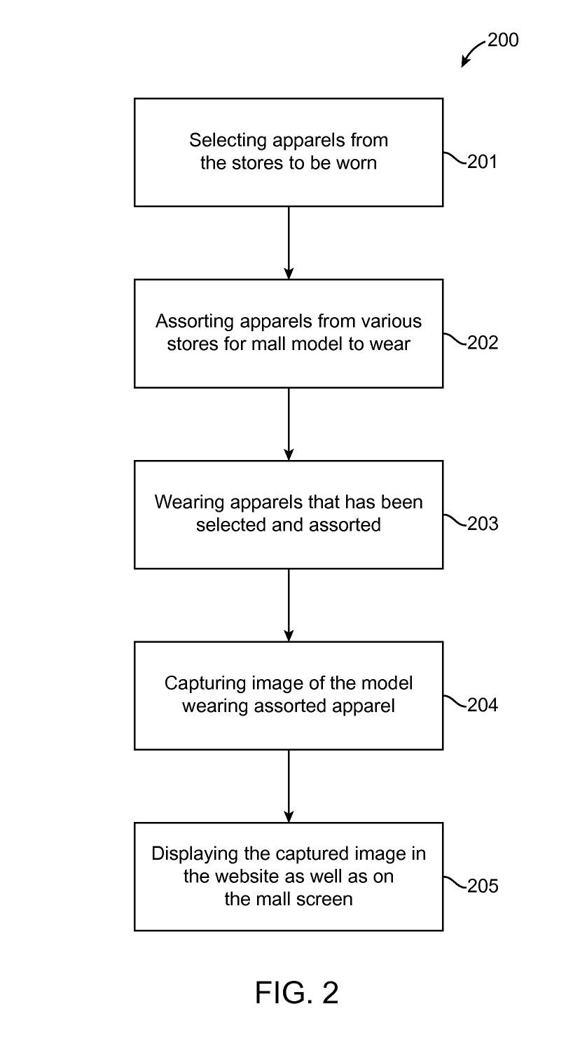

FIG. 2 is a flowchart depicting the method of capturing image of mall models and displaying on the websites and the mall screens in accordance to one or more embodiments of the invention. At step 201, the mall model (302) selects the apparel to wear. The assortment module at step 202 helps the mall model (302) to assort the apparels from the different stores in a mall (301) to be worn in combination. At step 203, the mall model (302) wears the selected and the desired apparel. After this, the image of the mall models (302) wearing the selected apparel is captured as in the step (204). At step 205, the captured images of the mall models (302) are displayed on the web page of the malls website and other social sites as well as on the mall screen. The mall models (302) are optionally asked to share the images in instagram, flicker, Facebook, or else with the acceptance of the mall model the images are automatically posted in the websites with a link to the website which hosts their photos. These pictures will be displayed in every city's local landing page, in which different combinations of tops, bottoms and accessories are displayed for the customers to look and buy.

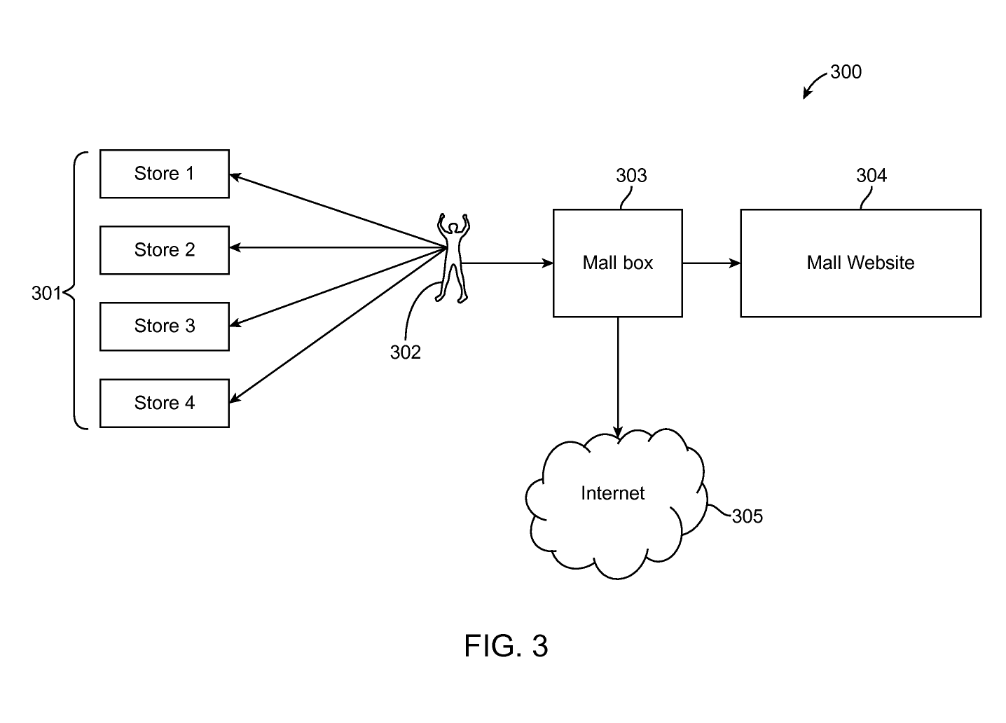

FIG. 3 is a block diagram depicting the system of capturing image of the mall models and displaying on the websites and the mall screens in accordance to one or more embodiments of the invention in which the mall model (302) who is selected from the local community and is generally a “boy next door and/or the girl next door”, a college student or anyone who is a good standing member of the community. The mall models (302) will have to get consent from a parent or a guardian if the model is a minor under the age of 18. Mall models (302) select apparels from different store of the mall (301). The mall model (302) may assort apparel from various stores (301) for wearing. The images of mall model (302) wearing apparels are captured through a mobile online photo studio present in the mall box (303) in various angles and the captured image is displayed on the mall screen, the mall website (304) and/or other social platforms such as facebook®, instagram®, flicker®, photo sharing sites, local landing page of each city etc. via internet (305).

The system and method for mall marketing is effective in displaying the assorted apparels from various store of a mall. In this manner, a single advertising method is utilized for sales promotion activities for various stores present in a mall that uses the medium such as the mall screens, the social websites, the mall websites etc. Also, the mall models used in this method are a good standing member of local community and hence already known personalities.

I claim:

1. A system for capturing image of mall models and displaying on websites and mall screens for advertising, the system comprising:
a) a selection module to select mall models among local community for wearing apparels;
b) an assortment module to assort apparels from different stores of a mall that mall models can wear;
c) an image capture module to capture the image of mall models wearing assorted apparels;
d) a display module to display the image of mall models wearing assorted apparels on website and mall screen; and
e) a campaign module for organizing fund raising programs and other events.

2. The system as claimed in claim 1, wherein said mall models are selected from local communities that are good standing members.

3. The system as claimed in claim 1, wherein said events include piano recital program and other extracurricular activities to drive traffic in mall.

4. The system as claimed in claim 1, wherein said image capture module captures image inside the store or in front of mall box.

5. The system as claimed in claim 1, wherein said image capture module includes a mobile onsite photo studio that captures images, from multiple angles, of the mall model wearing apparels.

6. The system as claimed in claim 1, wherein said image captured is displayed on social platform including at least one of instagram, flicker, facebook, every city's local landing page or other photo sharing sites with mall banner across the picture.

7. The system as claimed in claim 1, wherein said image captured is also displayed on a mall model's website along with the link to mall website where the image is hosted, only if the model grants permission.

8. The method of capturing image of mall models and displaying on websites and mall screens, the method comprising steps of:
a) selecting apparels to wear from various stores;
b) assorting apparels form a different store of the mall for mall models to wear;
c) capturing image of the mall model wearing assorted apparel;
d) displaying the captured image in the website as well as in the mall screen.

9. The method as claimed in claim 8 wherein said mall models are selected from local community and are good standing member of the community.

10. The method as claimed in claim 8 wherein said image is captured in the store or in front of mall box to be displayed in at least one of mall screens, websites such as instagram, flicker, facebook, every city's local landing page and other photo sharing sites with mall banner across the picture.
